(19) United States
(12) Patent Application Publication
(10) Pub. No.: US 2006/0106889 A1
(43) Pub. Date: May 18, 2006

(54) Method, system, and program for managing revisions to a file

(76) Inventor: Claes-Fredrik Urban Mannby, Issaquah, WA (US)

Correspondence Address: KONRAD RAYNES & VICTOR, LLP, 315 S. BEVERLY DRIVE, # 210, BEVERLY HILLS, CA, 90212, US

(21) Appl. No.: 10/987,382

(22) Filed: Nov. 12, 2004

(51) Int. Cl. G06F 17/30; G06F 12/00

(52) U.S. Cl. 707/203

(57) ABSTRACT

Provided are a method system and program for managing revisions to a file. A new version of a file is received including new modifications to an indicated version of the file. A current version of the file is accessed in response to determining that the indicated version is an earlier version than the current version. The indicated version of the file and the current version are compared to determine previous modifications of the current version over the indicated version. A determination is made as to whether the new modifications in the new version and the previous modifications of the current version affect at least one semantic unit in a conflicting manner with respect to the indicated version.

### BACKGROUND OF THE INVENTION

1. Field of the Invention

The present invention relates to a method, system, and program for managing revisions to a file.

2. Description of the Related Art

A source code control system provides revision control management of source code files that may be checked out by developers at different sites. These developers at the different sites may make local modifications to their copy of the same source file. As software is developed and deployed, multiple versions of the same source file may be worked on by developers. The source code control system ensures that two users making changes to the same file do not make conflicting changes, such that the changes overwrite the changes of one developer or cause an inconsistency in the code that makes the code unstable.

In the current art, if the source file being modified is a text file with carriage returns, then the source code control program performs a compare and merge to check modifications from two different developers on a line-by-line basis to the same version of the source code (the ancestor version). For changes made to a particular line, if there is no conflict, then the changes are made. If the changes being made from the different users are to a same line of text, then the last user checking-in their modifications is prompted to select which of the modifications to apply, or to make further, new changes to resolve the conflict.

Certain source code files are maintained in structured documents, such as Extensible Markup Language (XML) documents, having tags representing elements and attributes. If the source code control program processes changes from two users to such a structured document on a line-by-line basis, then a number of semantic violations may occur. A change in one part of a document or a related document may necessitate a corresponding change somewhere else in the document, but the user could choose to reject that change. For example, an element may be deleted, but not a reference to that element. Or the XML structure itself may be violated, for example as follows:

Ancestor:

<tag> foo
bar </tag>

Local contributor:
   <tag/>

Other contributor:

<tag> foo
baz </tag>

If line 1 is picked from the “local contributor”, and line 2 from the “other contributor”, then the following, illegal structure is created:

<tag />
baz </tag>

For this reason, some current source code control programs treat XML source files as “blobs”, such that different versions are not compared to determine if modifications should be permitted. In such cases where a merge and compare is not performed, such as for revision control of XML files, changes are only permitted to occur in a serial manner, where only one user may check out and modify a file at a time. Text files may be checked out to multiple users and revision control is managed by a compare and merge on a line-by-line basis.

In the current art, to circumvent the serial modification restriction of files treated as “blobs”, i.e., where a compare and merge is not performed, a user may edit a file without checking it out, and then check out the file when the file becomes available and perform a manual compare and merge of the current source file in the system with the source file the user modified. This approach depends on the user correctly choosing versions to compare and merge, and correctly performing a manual compare and merge, otherwise the user risks making inconsistent modifications that result in lost changes.

### SUMMARY

Provided are a method system and program for managing revisions to a file. A new version of a file is received including new modifications to an indicated version of the file. A current version of the file is accessed in response to determining that the indicated version is an earlier version than the current version. The indicated version of the file and the current version are compared to determine previous modifications of the current version over the indicated version. A determination is made as to whether the new modifications in the new version and the previous modifications of the current version affect at least one semantic unit in a conflicting manner with respect to the indicated version.

### BRIEF DESCRIPTION OF THE DRAWINGS

Referring now to the drawings in which like reference numbers represent corresponding parts throughout:

FIG. 1 illustrates a computing environment in which embodiments are implemented;

FIG. 2 illustrates file version information; and

FIGS. 3 and 4 illustrate revision control program operations to process modifications to a file.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

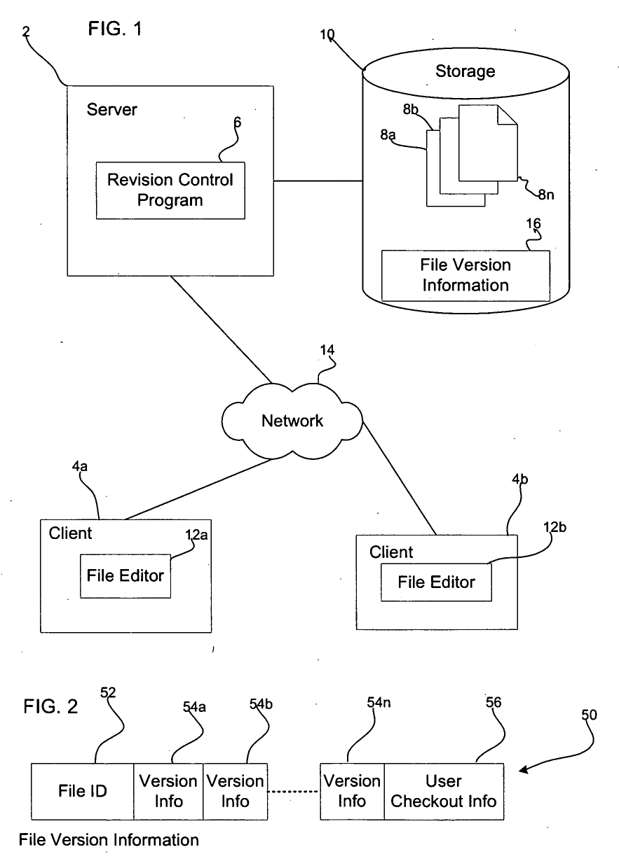

FIG. 1 illustrates a network computing environment including a server 2 and plurality of client systems 4a and 4b (there may be fewer or more than two client systems). The server 2 includes a revision control program 6, such as a source code control system, that manages modifications to files 8a, 8b . . . 8n in storage 10 by users at the different client systems 4a, 4b. The files 8a, 8b . . . 8n may comprise any electronic document file format known in the art, such as a text file, a structured document (e.g., XML, Hypertext Markup Language (HTML), a binary file, image, etc.) The files 8a, 8b . . . 8n may contain content types known in the art, such as source code. The revision control program 6 may manage a file version that is concurrently checked out to multiple users at the client systems 4a, 4b to modify and create new versions. Each client system 4a, 4b includes a file editor 12a, 12b capable of accessing and editing files 8a, 8b . . . 8n, and returning new versions having modifications to the revision control program 6. The file editors 12a, 12b may comprise software development tools to modify source code files, such as an Integrated Development Environment (IDE) software development tool. Alternatively, the file editors 12a, 12b may comprise any program capable of modifying the files 8a, 8b . . . 8n.

The server 2 and client systems 4a, 4b may communicate over a network 14 (e.g., Local Area Network (LAN), Storage Area Network (SAN), the Internet, an Intranet, etc.) or other data transfer interfaces known in the art, e.g., Advanced Technology Attachment (ATA), Serial ATA (SATA), Small Computer System Interface (SCSI), etc. The storage 10 may comprise any storage device known in the art, such as one storage device or multiple interconnected devices, such as disk drives, configured as a Redundant Array of Independent Disks (RAID), Just a Bunch of Disks (JBOD), Direct Access Storage Device (DASD), a tape storage device, a single or multiple storage units, e.g., a tape library, etc. The storage 10 and server 2 communicate over network or data interfaces known in the art or, alternatively, network 14.

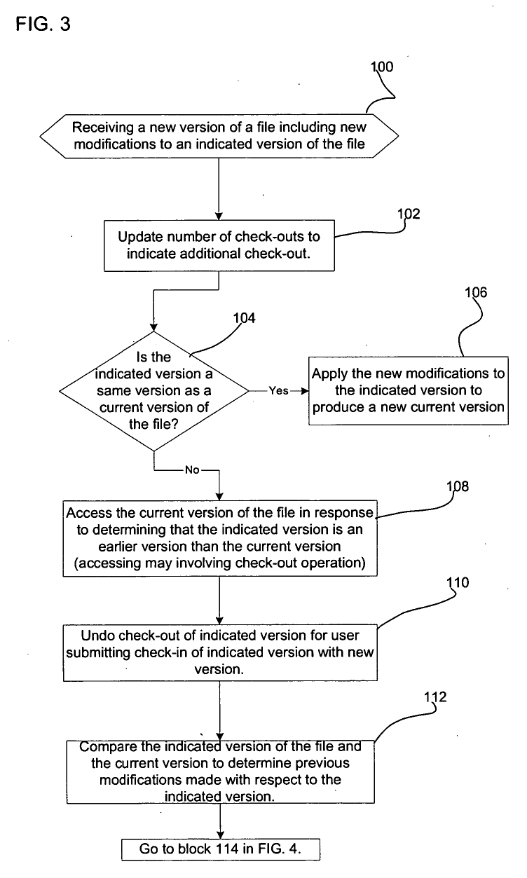

The revision control program 6 further maintains file version information 14 in the storage 10 providing information on each file and versions of the file. FIG. 2 illustrates an example of the file version information for each file managed by the revision control program 6. File version information 50 for a file that may be checked out to multiple users includes a file identifier 52, such as a pointer to the file, file name and directory location; file address, etc.; version information 54a, 54b . . . 54n, where the version information 54a, 54b . . . 54n may comprise a pointer to the full modified version of the file or a pointer to the modifications relative to the previous version, i.e., deltas; and user checkout information 56.

In embodiments where the version information 54a, 54b . . . 54n for each version comprises the modifications only, i.e., deltas, then the full file at a particular version 54a, 54b . . . 54n comprises a base file prior to any revisions and the aggregation of each subsequent revision 54a, 54b . . . 54n up until the particular revision, where the modifications are applied from the earliest revision 52a up until the particular version. In this way, the file at any revision may be readily reconstructed from the modifications maintained for each version 54a, 54b . . . 54n without having to store the full content of the file for each revision.

The user checkout information 56 may comprise information on a number of users that have checked-out the file and the identity of the users. When a user checks-in a new version of the file, the number of users having the file checked-out is decremented and the identity of the user removed. When a file with modifications is properly checked-in, then the revision control program 6 stores the modifications provided with the check-in as a latest version 54(n+1) of the file. In certain embodiments, the file version information 50 for the files 8a, 8b . . . 8n managed by the revision control program 6 may be maintained in a database or other data structures used to maintain metadata and information about files, such as tables, etc.

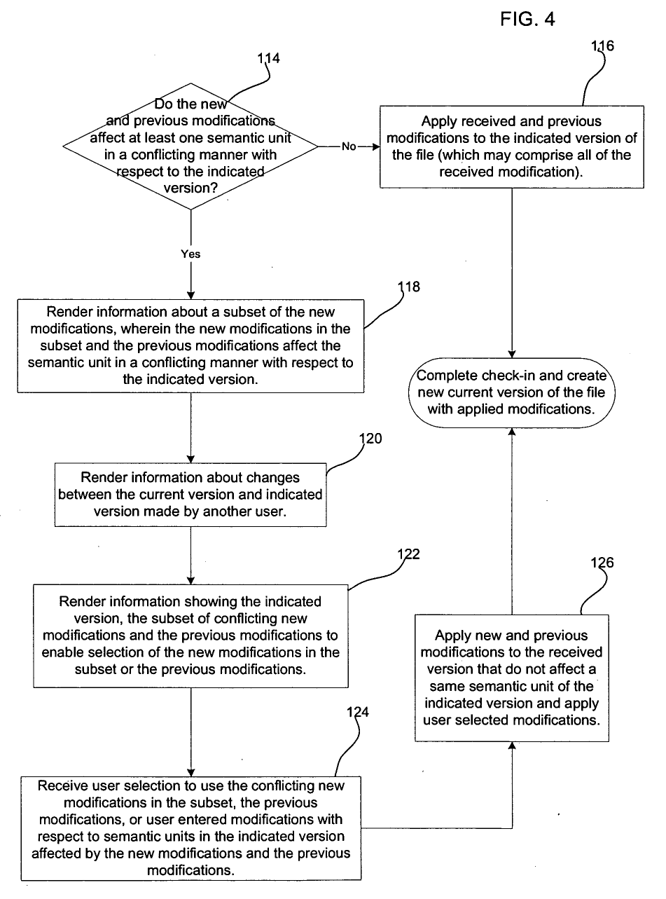

FIGS. 3 and 4 illustrate operations performed by the revision control program 6 to manage new revisions of a file from different users, who may be concurrently making changes to the file 8a, 8b . . . 8n, such as a source code file. Control begins upon the revision control program 6 receiving (at block 100) a request to update an indicated version, i.e., a checked-out version, of a file including new modifications to the indicated version of the file. The indicated version comprises the version the user initially checked out and the new modifications comprise the modifications the user checking in the indicated version wants to apply. The request may be invoked by a user running the file editor 12a, 12b in one client system 4a, 4b. Further, the request may comprise a check-in of the file 8a, 8b . . . 8n. The revision control program 6 may update (at block 102) the number of check-outs to indicate an additional check-out, where such information may be included in the user checkout information 56 in the file version information 50 for the file 8a, 8b . . . 8n subject to the check-in operation. If (at block 104) the indicated version subject to the new modifications is the same version as the current version, i.e., no intervening modifications were made since the indicated version was checked out, then the new modifications are applied (at block 106) to the indicated version, which is in this case the current version, to produce a new current version. Creating a new current version may involve adding version information, e.g., 56(n+1), providing a pointer to the received modifications or the full content of the file modified with the received modifications.

If (at block 104) the indicated version is an earlier version than the current version, i.e., the indicated version was subsequently modified by another user, then the current version of the file is accessed (at block 108). The indicated version is not the same as the current version if another user checked in modifications to the indicated version or a subsequent version while the indicated version was checked-out. The accessing operation may involve checking out the current version, i.e., version 54n and updating the user checkout information 56 for the file to indicate the additional checkout, as well as previous checking of the indicated version. In embodiments utilizing check-in and check-out procedures, the revision control program 6 may undo the checkout (at block 110) of the indicated version for the user checking in the indicated version and new modifications, so that the user then has the current version checked-out, with their check-out of the indicated version undone.

The revision control program 6 compares (at block 112) the older indicated version of the file and the current version, as represented by version information 54n, to determine previous modifications the current version makes with respect to the indicated version. The previous modifications comprise those modifications made by the last user that successfully checked-in the current version with respect to the indicated version, i.e., the difference or delta between the current version and the indicated version.

The operation of comparing the previous modifications with the new modifications may involve examining each line of the text in the indicated version and determining whether there are new modifications and/or previous modifications (made by the user that checked in the current version) affecting the same or related information. For instance, the comparison operation may involve examining the modifications to determine changes on a line-by-line basis or modifications to document data structures. For instance, the comparison of changes may involve determining whether the changes affect: (1) the structural integrity (structures may span lines, as in the example with <tag> and <foo>), (2) referential integrity (references from one element or attribute to another element or attribute may span structures and even documents, and need to be maintained consistent—which may involve pointing a reference at a new location if the target element has moved or deleting the reference if the target element has been deleted; and (3) domain specific integrity (the data being stored may have further rules, e.g. preventing two elements of the same name from being owned by a containing element, navigating multiple references within the information structure, etc.). Thus, the comparison operation may involve detecting conflicting modifications to any semantic unit in the documents. A “semantic unit” comprises any information, tag, element, reference or data structure in a document that may be subject to modifications in a conflicting manner, where a modification in a “conflicting manner” comprises modifications to the semantic unit that are mutually inconsistent or that violate document or language rules.

If (at block 114) all the new and previous modifications do not affect at least one semantic unit with respect to the indicated version in a conflicting manner, then the revision control program 6 applies (at block 116) the new and previous modifications to the indicated version of the file, so that the differences between the current version and indicated version (previous modifications) and the new modifications are both made. Otherwise, if (at block 114) there are some new and previous modifications affecting a semantic unit in a conflicting manner with respect to the indicated version, then the revision control program 6 renders (at block 118) information about a subset of the new modifications, where the new modifications in the subset affect semantic units in the indicated version affected by the previous modifications. The revision control program 6 may further render (at block 120) information about changes between the current version and the indicated version. Yet further, the revision control program 6 may render (at block 122) information showing the indicated version, the subset of conflicting new modifications and the previous modifications to enable user selection of the conflicting new modifications in the subset or the previous modifications to be applied to the indicated version.

The rendered information may be rendered at the client systems 4a, 4b, where the information is communicated from the server 2 to the client systems 4a, 4b. This information allows the user of the file editor 12a, 12b to view the indicated version and the previous modifications, which added to the indicated version results in the current version, and the new modifications the user wants to add. This allows the user to view the new modifications to semantic units the user provided that conflict with the previous modifications to semantic units made by the last user with respect to the indicated version. The user may then select (at block 124) to use the conflicting new modifications, the previous modifications, or user entered modifications with respect to semantic units in the indicated version modified by both the new modifications and the previous modifications. The user may be presented with information on conflicts to modify or accept in an interactive format.

Further, the described embodiments perform the compare and merge procedure in a manner that prevents users from circumventing the proper workflow by automatically performing the compare and merge operations on any file a user presents to check in so that any conflicting modifications between the proposed modifications and previous modifications are flagged for user review and action.

Described embodiments provide techniques to manage changes to versions of a file checked out when different users may make changes and check in those changes at different times so that consistent, non-conflicting changes are allowed and conflicting changes are handled in a manner to avoid allowing conflicting changes.

### ADDITIONAL EMBODIMENT DETAILS

The described operations may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The described operations may be performed by circuitry, where “circuitry” refers to either hardware or software or a combination thereof. The circuitry for performing the operations of the described embodiments may comprise a hardware device, such as an integrated circuit chip, Programmable Gate Array (PGA), Application Specific Integrated Circuit (ASIC), etc. The circuitry may also comprise a processor component, such as an integrated circuit, and code in a computer readable medium, such as memory, wherein the code is executed by the processor to perform the operations of the described embodiments.

In described embodiments, the revision control program received modifications from file editor programs on different client systems over a network. In alternative embodiments, the revision control program may execute on the same system running the file editor.

The illustrated operations of FIGS. 3 and 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
receiving a new version of a file including new modifications to an indicated version of the file;
accessing a current version of the file in response to determining that the indicated version is an earlier version than the current version;
comparing the indicated version of the file and the current version to determine previous modifications of the current version over the indicated version; and
determining whether the new modifications in the new version and the previous modifications of the current version affect at least one semantic unit in a conflicting manner with respect to the indicated version.

2. The method of claim 1, further comprising:
applying new modifications to the indicated version of the file in response to determining that the new modifications and the previous modifications do not affect the at least one semantic unit in the conflicting manner in the indicated version.

3. The method of claim 2, wherein the applied new modifications comprise a subset of the new modifications that are automatically applied to the indicated version.

4. The method of claim 3, wherein the subset of the new modifications comprises a first subset, further comprising:
rendering information about a second subset of the received modifications, wherein the received modifications in the second subset and the previous modifications affect the at least semantic unit with in the conflicting manner with respect to the indicated version.

5. The method of claim 4, wherein rendering the information further comprises:
rendering information showing the indicated version, the second subset of the new modifications and the previous modifications to enable selection for semantic units in the indicated version of the new modifications in the second subset or the previous modifications.

6. The method of claim 4, further comprising:
receiving user selection to use the new modifications in the second subset, the previous modifications, or user-entered modifications with respect to semantic units in the indicated version affected in the conflicting manner by the new modifications in the second subset and the previous modifications.

7. The method of claim 1, further comprising:
maintaining, for a base file, modifications for each version of the base file, wherein the previous modifications comprise maintained modifications for the file.

8. The method of claim 1, wherein the file comprises a source code file managed by a source code control system, wherein the request is received at the source code control system from one of a plurality of client systems coupled to the source code control system, and wherein the source code control system performs the operations of accessing the current version, comparing the indicated version and the current version, and determining whether the new and previous modifications affect the at least one semantic unit in the conflicting manner in the indicated version.

9. The method of claim 1, wherein the file comprises a document having tags designating elements and attributes used to represent content of the file.

10. The method of claim 1, wherein receiving the new version of the file is part of a request to check in the indicated version with the new modifications, and wherein the indicated version was previously checked out to a user that submitted the check-in of the indicated version and modifications, further comprising:
undoing the check-out of the indicated version in response to determining that the indicated version is the earlier version, wherein accessing the current version comprises checking-out the current version; and
checking-in the current version and at least some of the new modifications.

11. A system, comprising:
a processor;
a memory;
a storage including files;
code in the memory executed by the processor to perform operations, the operations comprising:
(i) receiving a new version of one of the files including new modifications to an indicated version of the file;
(ii) accessing a current version of the file in response to determining that the indicated version is an earlier version than the current version;
(iii) comparing the indicated version of the file and the current version to determine previous modifications of the current version over the indicated version; and
(iv) determining whether the new modifications in the new version and the previous modifications of the current version affect at least one semantic unit in a conflicting manner with respect to the indicated version.

12. The system of claim 11, wherein the operations further comprise:
applying new modifications to the indicated version of the file in response to determining that the new modifications and the previous modifications do not affect the at least one semantic unit in the conflicting manner in the indicated version.

13. The system of claim 12, wherein the applied new modifications comprise a subset of the new modifications that are automatically applied to the indicated version.

14. The system of claim 13, wherein the subset of the new modifications comprises a first subset, further comprising:
rendering information about a second subset of the received modifications, wherein the received modifications in the second subset and the previous modifications affect the at least semantic unit with in the conflicting manner with respect to the indicated version.

15. The system of claim 14, wherein rendering the information further comprises:
rendering information showing the indicated version, the second subset of the new modifications and the previous modifications to enable selection for semantic units in the indicated version of the new modifications in the second subset or the previous modifications.

16. The system of claim 14, wherein the operations further comprise:
receiving user selection to use the new modifications in the second subset, the previous modifications, or user-entered modifications with respect to semantic units in the indicated version affected in the conflicting manner by the new modifications in the second subset and the previous modifications.

17. The system of claim 11, wherein the operations further comprise:
maintaining, for a base file, modifications for each version of the base file, wherein the previous modifications comprise maintained modifications for the file.

18. The system of claim 11, wherein the file comprises a source code file managed by a source code control system, wherein the request is received at the source code control system from one of a plurality of client systems coupled to the source code control system, and wherein the source code control system performs the operations of accessing the current version, comparing the indicated version and the current version, and determining whether the new and previous modifications affect the at least one semantic unit in the conflicting manner in the indicated version.

19. The system of claim 11, wherein the file comprises a document having tags designating elements and attributes used to represent content of the file.

20. The system of claim 11, wherein receiving the new version of the file is part of a request to check in the indicated version with the new modifications, and wherein the indicated version was previously checked out to a user that submitted the check-in of the indicated version and modifications, wherein the operations further comprise:
undoing the check-out of the indicated version in response to determining that the indicated version is the earlier version, wherein accessing the current version comprises checking-out the current version; and
checking-in the current version and at least some of the new modifications.

21. An article of manufacture for causing operations to be performed, the operations comprising:
receiving a new version of a file including new modifications to an indicated version of the file;
accessing a current version of the file in response to determining that the indicated version is an earlier version than the current version;
comparing the indicated version of the file and the current version to determine previous modifications of the current version over the indicated version; and
determining whether the new modifications in the new version and the previous modifications of the current version affect at least one semantic unit in a conflicting manner with respect to the indicated version.

22. The article of manufacture of claim 21, wherein the operations further comprise:
applying new modifications to the indicated version of the file in response to determining that the new modifications and the previous modifications do not affect the at least one semantic unit in the conflicting manner in the indicated version.

23. The article of manufacture of claim 22, wherein the applied new modifications comprise a subset of the new modifications that are automatically applied to the indicated version.

24. The article of manufacture of claim 23, wherein the subset of the new modifications comprises a first subset, wherein the operations further comprise:
rendering information about a second subset of the received modifications, wherein the received modifications in the second subset and the previous modifications affect the at least semantic unit with in the conflicting manner with respect to the indicated version.

25. The article of manufacture of claim 24, wherein rendering the information further comprises:
rendering information showing the indicated version, the second subset of the new modifications and the previous modifications to enable selection for semantic units in the indicated version of the new modifications in the second subset or the previous modifications.

26. The article of manufacture of claim 24, wherein the operations further comprise:
receiving user selection to use the new modifications in the second subset, the previous modifications, or user-entered modifications with respect to semantic units in the indicated version affected in the conflicting manner by the new modifications in the second subset and the previous modifications.

27. The article of manufacture of claim 21, wherein the operations further comprise:
maintaining, for a base file, modifications for each version of the base file, wherein the previous modifications comprise maintained modifications for the file.

28. The article of manufacture of claim 21, wherein the file comprises a source code file managed by a source code control system, wherein the request is received at the source code control system from one of a plurality of client systems coupled to the source code control system, and wherein the source code control system performs the operations of accessing the current version, comparing the indicated version and the current version, and determining whether the new and previous modifications affect the at least one semantic unit in the conflicting manner in the indicated version.

29. The article of manufacture of claim 21, wherein the file comprises a document having tags designating elements and attributes used to represent content of the file.

30. The article of manufacture of claim 21, wherein receiving the new version of the file is part of a request to check in the indicated version with the new modifications, and wherein the indicated version was previously checked out to a user that submitted the check-in of the indicated version and modifications, wherein the operations further comprise:
undoing the check-out of the indicated version in response to determining that the indicated version is the earlier version, wherein accessing the current version comprises checking-out the current version; and
checking-in the current version and at least some of the new modifications.
